(19) United States
(12) Patent Application Publication
(10) Pub. No.: US 2016/0137274 A1
(43) Pub. Date: May 19, 2016

(54) MAGNET SYSTEM FOR REMOVABLE ATTACHMENT OF AN ACCESSORY TO PERSONAL WATERCRAFT

(71) Applicant: Sean Peterson, San Jose, CA (US)

(72) Inventor: Sean Peterson, San Jose, CA (US)

(21) Appl. No.: 15/004,496

(22) Filed: Jan. 22, 2016

Related U.S. Application Data
(63) Continuation-in-part of application No. 14/815,856, filed on Jul. 31, 2015.
Application No. 14/815,856 is a continuation-in-part of application No. 13/965,706, filed on Aug. 13, 2013, now Pat. No. 9,126,313.

(51) Int. Cl. B63B 35/85; B63B 35/71; H01F 7/02; B63B 35/79

(52) U.S. Cl. CPC B63B 35/85; B63B 35/79; B63B 35/71; H01F 7/0205; B63B 2035/715

(57) ABSTRACT

An attachment system secures an accessory to a personal watercraft. A magnet is attached or embedded within a top surface of the personal watercraft. A protective covering protects the magnet from water. A metal piece is within or attached to the accessory. The metal piece is arranged with the accessory so that a magnetic bond between the magnet and the metal piece holds the top accessory to the top surface. A protective covering that protects the metal piece from water.

### BACKGROUND

A personal watercraft is a kayak or water board such as a surfboard, paddleboard or stand-up paddleboard used in various water sports and recreation activities. Often one using a kayak or water board is on the water for a long period of time. Because water boards and kayaks often have a flat surface, this limits storage options for accessories such as water bottles and smart phones. This is especially true when water surface is uneven because of the presence of waves.

### BRIEF DESCRIPTION OF THE DRAWINGS

FIG. 1 is a perspective view of a bag removably secured to a water board with a magnet system for bag attachment in accordance with an embodiment.

FIG. 2 is a perspective view of a water board with four metal discs retained thereupon of a magnet system for bag attachment in accordance with an embodiment.

FIG. 3A is a bottom view of a left portion of a bag with two magnets retained therein of a magnet system for bag attachment in accordance with the present invention.

FIG. 3B is a bottom view of a right portion of a bag with two magnets retained thereon of a magnet system for bag attachment in accordance with an embodiment.

FIG. 4 is a partially exploded end view of a bag with at least one magnet and a securing device of a magnet system for bag attachment in accordance with an embodiment.

FIG. 5 is a partially exploded end view of a bag with at least one magnet of a magnet system for bag attachment in accordance with an embodiment.

FIG. 6 is a partially exploded end view of a water board with at least one magnet and a securing device of a magnet system for bag attachment in accordance with an embodiment.

FIG. 7 is a partially exploded cross sectional end view of a water board with at least one magnet of a magnet system for bag attachment in accordance with an embodiment.

FIG. 8 is illustrates a bag ready to be attached to a water board in accordance with an embodiment.

FIG. 9 shows an exploded view of an embodiment of a bag ready to hold and protect an electronic device in accordance with an embodiment.

FIG. 10 shows an embodiment of a storage bag in an open position ready to hold fishing tackle in accordance with an embodiment.

FIG. 11 shows the storage bag of FIG. 10 shown in a closed position in accordance with an embodiment.

FIG. 12 shows an exploded view of the storage bag shown in FIG. 10 in accordance with an embodiment.

FIG. 13 illustrates attaching a light to a water board in accordance with an embodiment.

FIG. 14 and FIG. 15 illustrate that the arrangement of magnets and metal pieces are interchangeable in accordance with embodiments.

### DETAILED DESCRIPTION OF THE EMBODIMENTS

In accordance with various implementations, an attachment system secures an accessory to a personal watercraft. One of a magnet or a metal piece is arranged to be attached or embedded within a top surface of the personal watercraft. The other of the magnet and the metal piece is within or attached to the accessory. The magnetic bond between the magnet and the metal piece holds the top accessory to the top surface. A protective covering protects the magnet from water and a protective covering protects the metal piece from water. The protective covering can be, for example, a coating of waterproof material, a waterproof compartment or a waterproof pouch or some other waterproof protective covering.

For example, the magnet is embedded in a bore within the top surface so that the top surface is smooth at a location where the magnet is embedded within the top surface. For example, the metal piece is a metal disk. For example, the magnet is attached by an adhesive to the top surface. For example, the personal watercraft is a kayak, a surfboard, a stand-up paddle board, or some another type of water board. For example, the accessory is a storage bag, a bottle sleeve, a lighting device, fishing pole holder, a tackle bag configured to hold fishing tackle, a waterproof pouch sized to contain a small electronic device such as a smart phone or a global positioning system (GPS) device, or any other type accessory that could be used with a water board or a kayak.

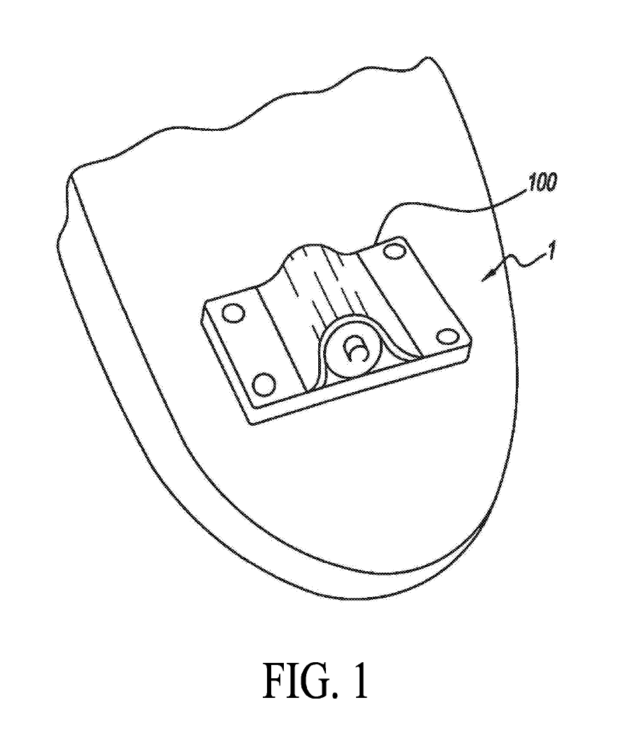

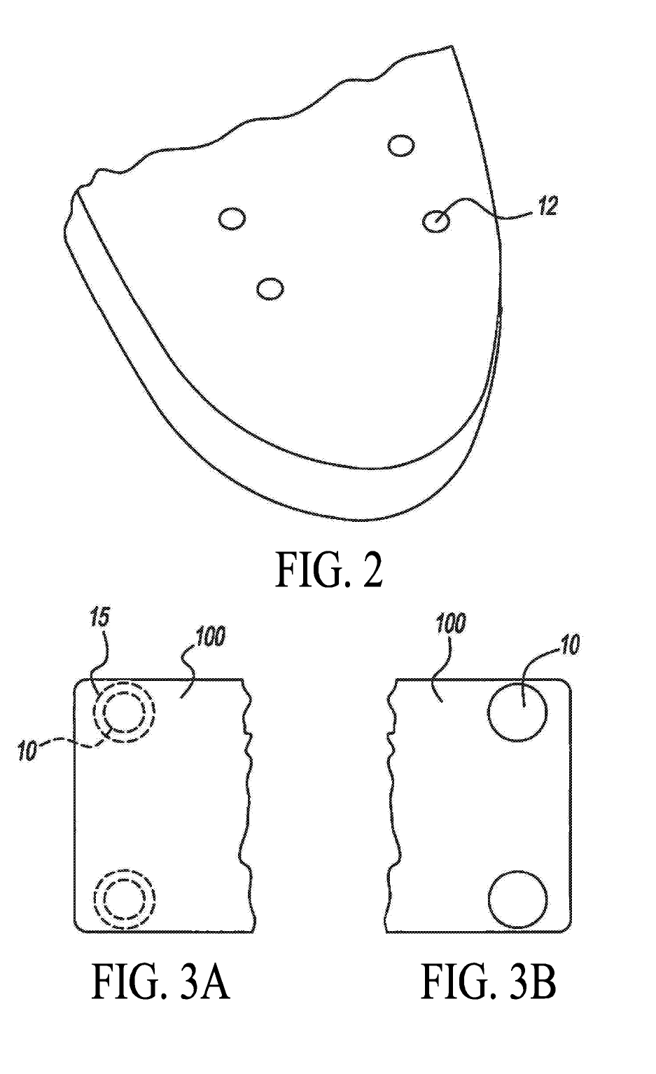

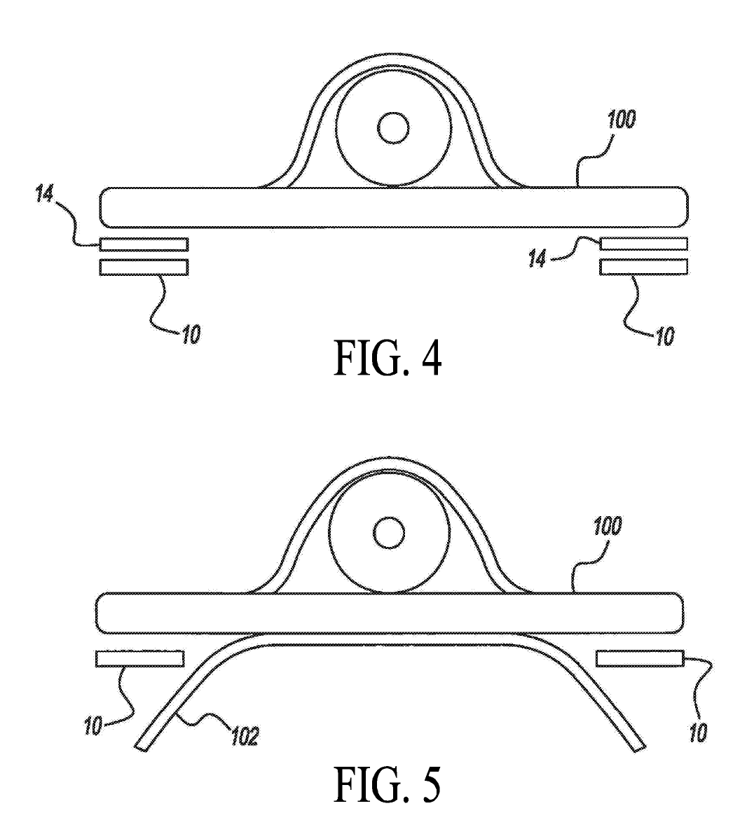

With reference now to the drawings, and particularly to FIG. 1, there is shown a perspective view of a magnet system for bag attachment 1. With reference to FIGS. 2-3b, the magnet system for bag attachment 1 preferably includes at least one magnet 10 and at least one metal disc 12. The at least one magnet 10 is retained in or on a bottom of a bag 100. With reference to FIGS. 4-5, the at least one magnet 10 is preferably retained in a bottom wall 102 of the bag 100; attached to the bag 100 with a piece of double sided tape 14; or attached with any other suitable attachment method. The at least one magnet 10 may be retained in a bottom of the bag 100 by retaining the at least one magnet 10 between two pieces of material in the bottom wall 102 and around at least a portion of the perimeter of the at least one magnet 10. The at least one metal disc 12 must fabricated of a ferrous material, such as steel.

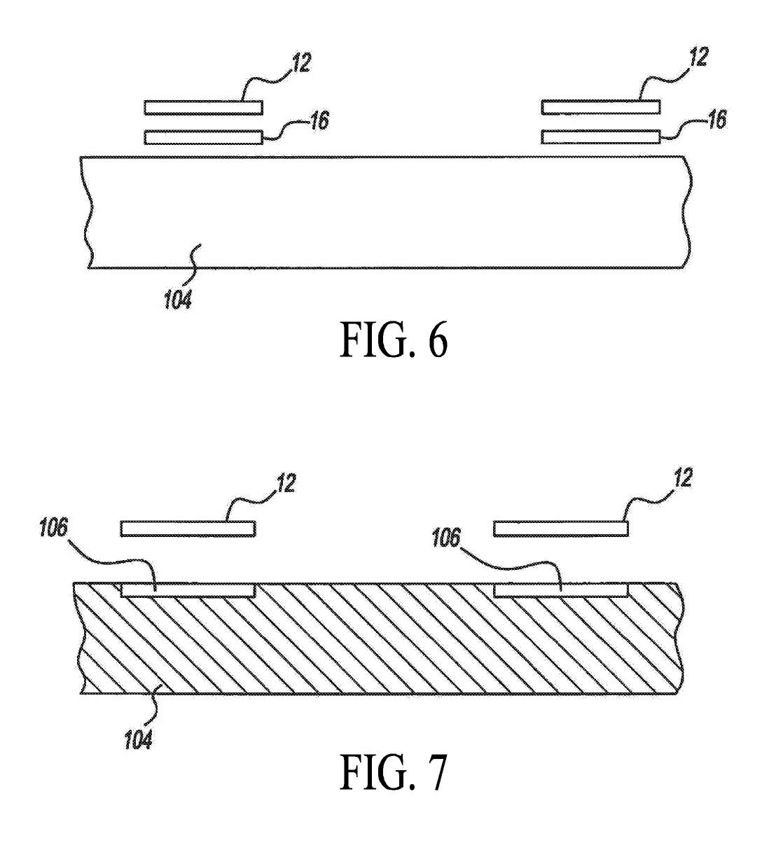

With reference to FIGS. 6 and 7, the at least one metal disc 12 is coated with a water impermeable substance to prevent rusting. The at least one metal disc 12 is retained on a surface of a water board 104 or kayak. The at least one metal disc 12 may be attached to a water board 104 with a piece of double sided tape 16, pressed into a bore 106 formed in the water board 104, or secured to the water board 104 with any other suitable method. The bag 100 will be removably retained relative to the water board 104, when a magnetic field of the at least one magnet 10 is in contact with the at least one metal disc 12.

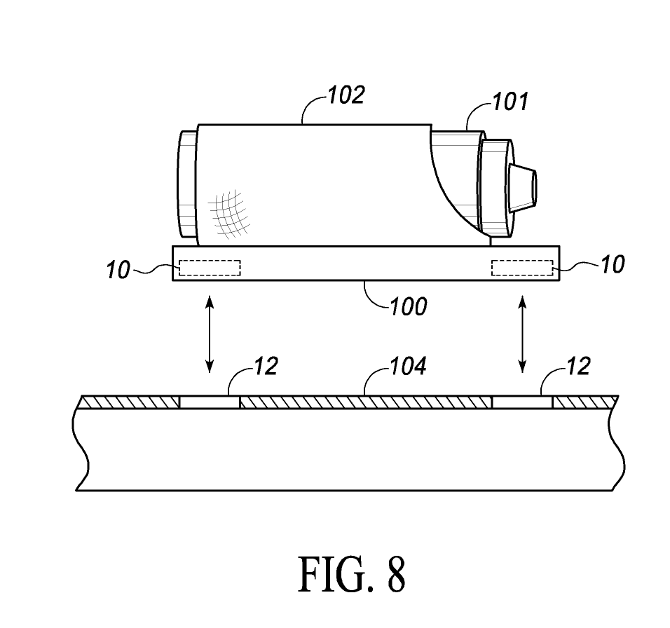

FIG. 8 shows metal discs 12 embedded in water board 104. A water bottle 101 is stored within a bottle sleeve 102.

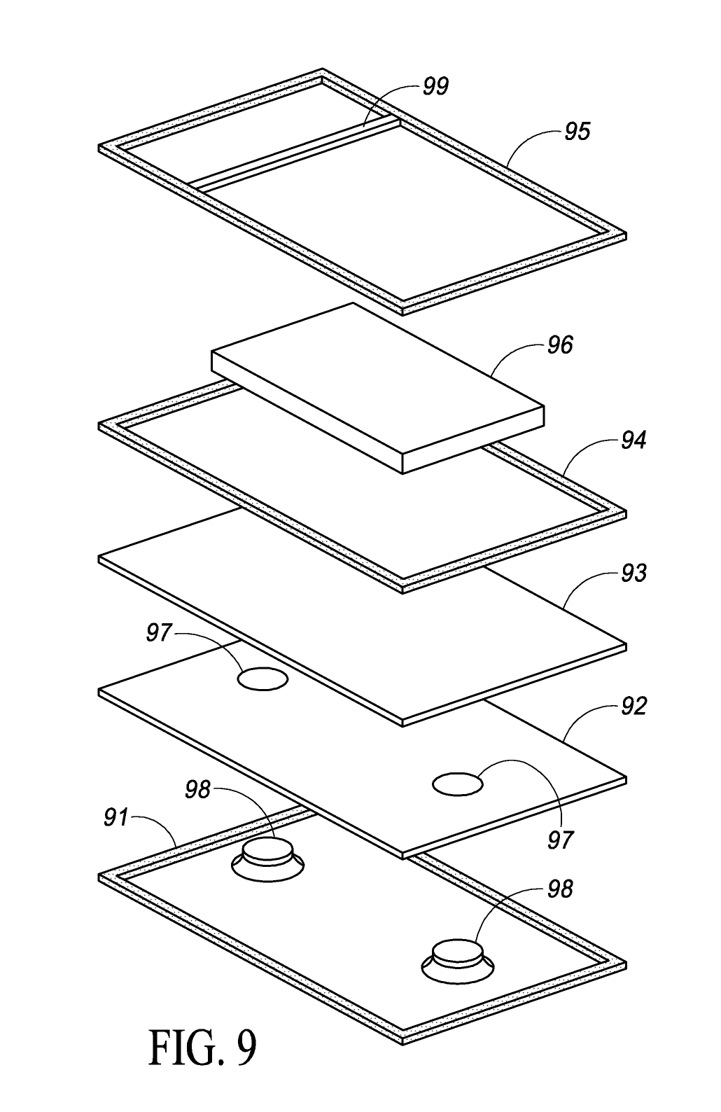

FIG. 9 shows an exploded view of an embodiment of a bag ready to hold and protect an electronic device, such as a smart phone, a global positioning system (GPS) device or a tablet computer. A waterproof layer 91 will come into contact with the water board or kayak. Magnet pouches 98 are RF welded to waterproof layer 91. Magnet pouches 98 are used to hold magnets in place against waterproof layer 91 and to protect the magnets from moisture. When assembled, magnet pouches 98 are within holes 97 of mounting material 92. For example, mounting material 92 is a one-quarter inch thick foam layer. Alternatively, mounting material 92 may be incorporated into waterproof layer 91.

For example, a layer 93 is placed over mounting material 92. For example, layer 93 is a one-quarter inch thick foam layer. A waterproof layer 94 is placed over layer 93. For example, edges of waterproof layer 91 are sealed with edges of layer 94 to form waterproof material that protects magnet pouches 98, mounting material 92 and layer 93 protected from moisture. For example, the seal is accomplished using radio frequency (RF) heat sealing.

A waterproof layer 95 is placed over layer 94. For example, edges of layer 95 are sealed with edges of layer 94 to form a water proof pouch area in which contents may be stored that are protected from moisture. For example, the seal is accomplished using radio frequency (RF) heat sealing. An electronic device 96 can be stored in the pouch area between layers 94 and 95. A zipper 99 or other waterproof fastener is used to allow electronic device 96 to be placed in and removed from the pouch area. For example, layer 95 is clear plastic allowing electronic device 96 to be viewed while within the pouch area. For example, electronic device 96 is a smart phone, GPS device, tablet computer or other electronic device.

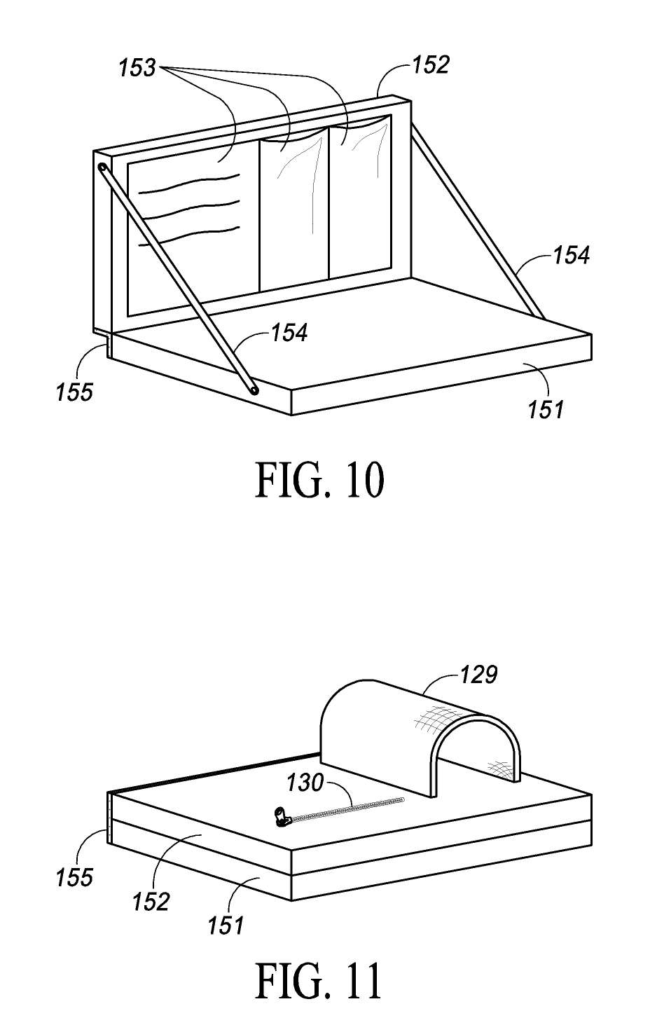

FIG. 10 shows an embodiment of a storage bag configured for fishing tackle. A top portion 152 is attached to a bottom portion 151 via a hinge 155. For example, hinge 155 is accomplished using a dielectric seal accomplished via radio frequency (RF) heat sealing. Straps 154 can be used to limit the range of motion between top portion 152 and bottom portion 151. Various pouches 153 (waterproof and otherwise) are organized within top portion 152 to allow storage of fishing tackle.

FIG. 11 shows top portion 152 shut against bottom portion 151. Top portion 152 is shown to include an outside pouch accessible via a zipper 130. A bottle sleeve 129 is located conveniently to hold a water bottle or other container.

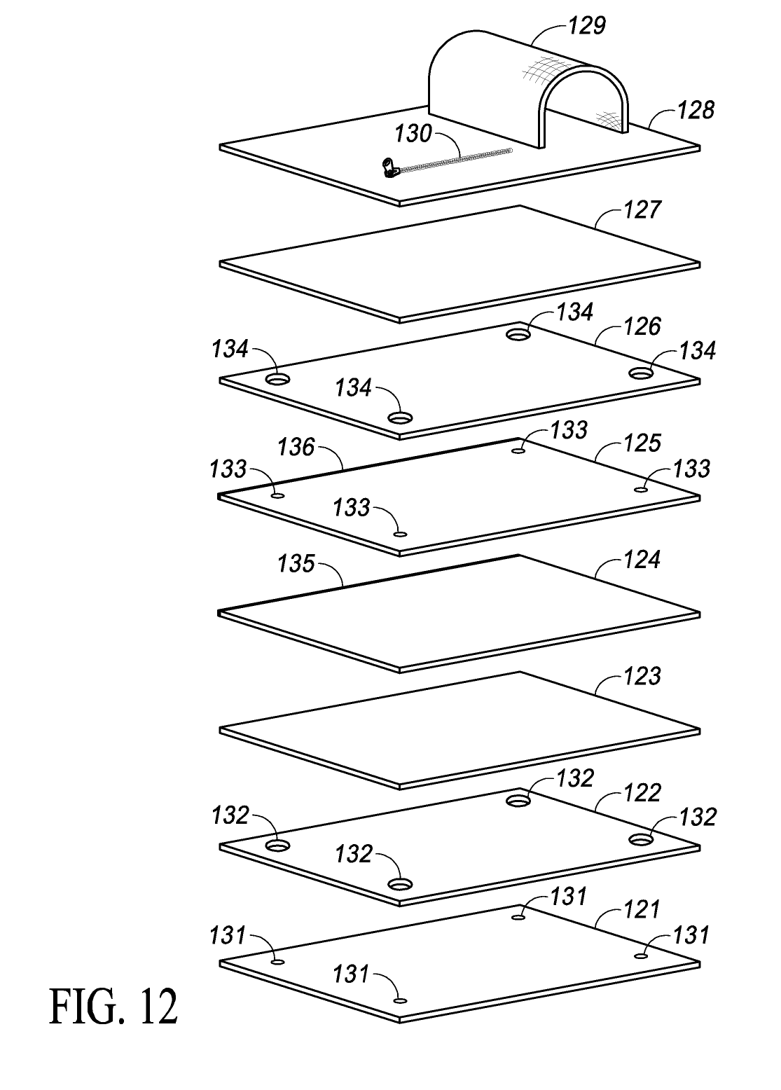

FIG. 12 shows an exploded view of the storage bag shown in FIG. 10 and FIG. 11. A waterproof layer 121 will come into contact with the water board or kayak. Magnets 131 are located on layer 121 and within cut out holes 132 of layer 122. For example layer 122 is a one-quarter inch thick foam layer. For example, a layer 123 is placed over layer 122. For example, layer 123 is a one-quarter inch thick foam layer. A waterproof layer 124 is placed over layer 123. For example, edges of layer 121 are sealed with edges of layer 124 to keep layers 122 and 123 protected from moisture. For example, the seal is accomplished using radio frequency (RF) heat sealing. Layers 121 through 124 together form bottom portion 151 of the storage bag configured for fishing tackle.

A waterproof layer 125 is placed over layer 124. Hinge 155 (shown in FIGS. 10 and 11) is formed at an intersection of edge 135 of layer 124, and edge 136 of layer 125.

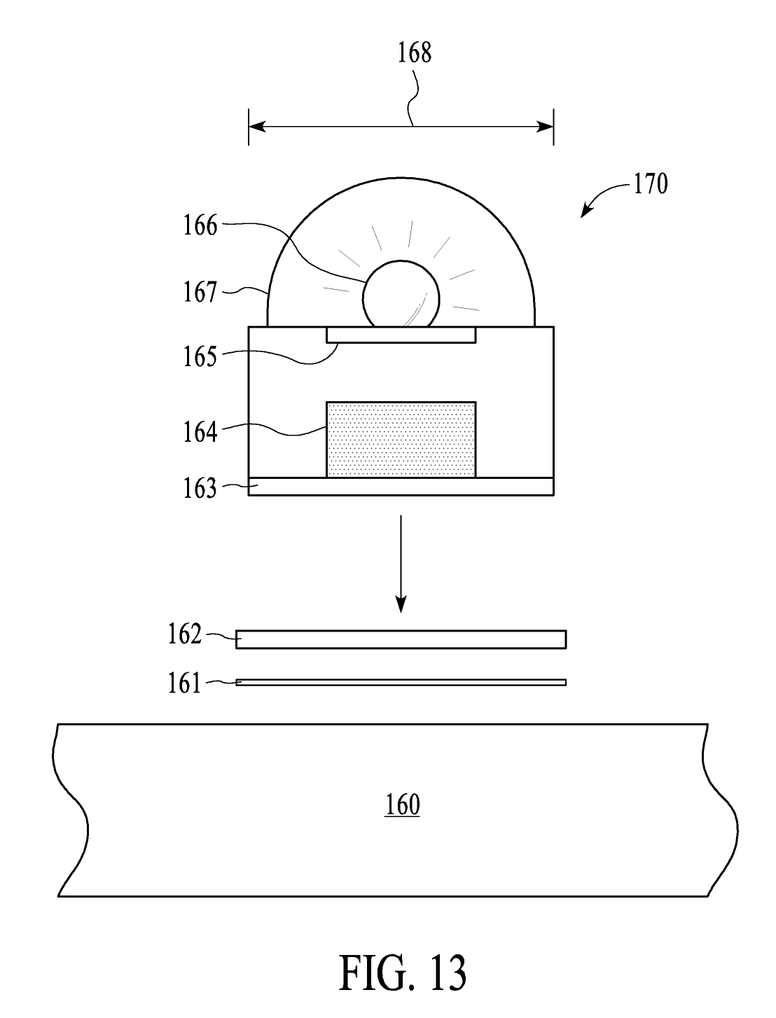

FIG. 13 illustrates attaching a lighting device 170 to a water board 160 or kayak. A metal disc 162 is attached to a water board 160 with a piece of double sided tape 161 or other adhesive. Alternatively, metal disc 162 is embedded in water board 160, for example by being pressed into a bore formed in water board 162 is or secured to the water board 160 or other personal watercraft with any other suitable method. Lighting device 170 will be removably retained relative to water board 162, when a magnetic field of a magnet 164 is in magnetic contact with metal disk 162. For example, a water tight cap 163 is over magnet 164 to protect magnet 164 from moisture etc. A light 166 is powered by a battery 165. For example light 166 is an LED light or a light made from another suitable technology. LED may be of any desired color and magnitude. A cover 167 protects light 166 from moisture etc. For example, a diameter 168 of light 170 is approximately two inches.

While in the examples above, one or more metal pieces are attached to the water board and one or more magnets are included within an accessory, the arrangement of the magnets and metal pieces are interchangeable.

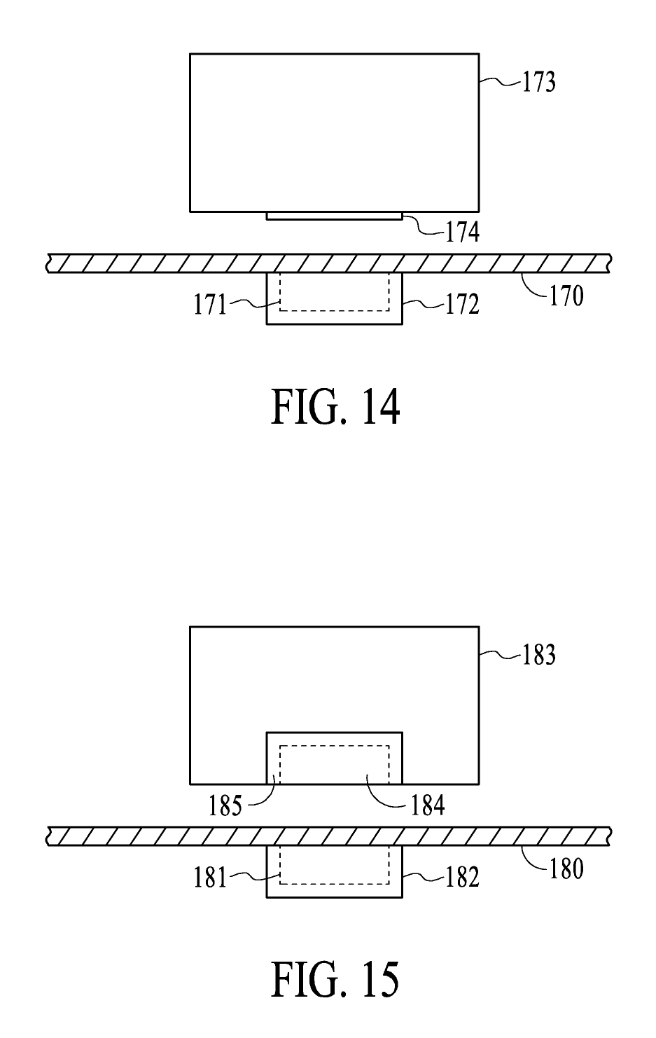

For example, FIG. 14 shows a top surface 170 of a personal watercraft such as a water board or a kayak used in various water sports and recreation activities. A magnet 171 is embedded within in a bore or waterproof compartment 172 within top surface 170 of the personal watercraft. A metal piece 174 is coated with a waterproof coating or within a waterproof compartment and attached to an accessory 173. For example, accessory 173 is a storage bag, a bottle sleeve, a lighting device, a tackle bag configured to hold fishing tackle, a fishing rod holder, fishing pole, a waterproof pouch sized to contain a small electronic device such as a smart phone or a global positioning system (GPS) device, or any other type accessory that could be used with a water board or a kayak.

The arrangement of the magnet and the metal piece may be interchanged freely. For example, FIG. 15 shows a top surface 180 of a personal watercraft such as a water board or a kayak or another type of small one or two person vessels used in various water sports and recreation activities. A metal piece 181 is embedded within in a bore or waterproof compartment 182 within top surface 180 of the personal watercraft. A magnet 184 is within a waterproof compartment 185, is coated with a waterproof coating or employs another type of protective covering that protects magnet 184 from water. A magnet 184 is attached to or placed within accessory 183. For example, accessory 183 is a storage bag, a bottle sleeve, a lighting device, a tackle bag configured to hold fishing tackle, a fishing rod holder, fishing pole, a waterproof pouch sized to contain a small electronic device such as a smart phone or a global positioning system (GPS) device, or any other type accessory that could be used with a water board or a kayak.

In FIGS. 1 through 13, the arrangements of metal pieces and magnets are interchangeable just as the arrangements of metal pieces and magnets shown in FIGS. 14 and 15 are interchangeable.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. An attachment system for securing an accessory to a personal watercraft comprising:
a magnet attached or embedded within a top surface of the personal watercraft;
a protective covering that protects the magnet from water;
a metal piece within or attached to the accessory, the metal piece being arranged with the accessory so that a magnetic bond between the magnet and the metal piece holds the top accessory to the top surface; and,
a protective covering that protects the metal piece from water.

2. An attachment system as in claim 1 wherein the magnet is embedded in a bore within the top surface so that the top surface is smooth at a location where the magnet is embedded within the top surface.

3. An attachment system as in claim 1 wherein the metal piece is a metal disk.

4. An attachment system as in claim 1 wherein the magnet is attached by an adhesive to the top surface.

5. An attachment system as in claim 1 wherein the personal watercraft is one of the following:
surfboard;
stand-up paddle board;
kayak.

6. An attachment system as in claim 1 wherein the accessory is at least one of the following:
a waterproof pouch sized to contain a small electronic device such as a smart phone or a global positioning system (GPS) device;
a storage bag;
a bottle sleeve;
lighting device;
a tackle bag, configured to hold fishing tackle;
fishing rod holder;
fishing pole.

7. A personal watercraft comprising:
a top surface;
a magnet embedded within the top surface of the personal watercraft; and,
a protective covering that protects the magnet from water;
wherein the magnet is sufficiently strong to create a bond between a metal piece within or attached to an accessory so that the accessory is held firmly to the top surface of the personal watercraft; and, wherein a protective covering protects the metal piece from water.

8. A personal watercraft as in claim 7 wherein the magnet is embedded in a bore within the top surface so that the top surface is smooth at a location where the magnet is embedded within the top surface.

9. A personal watercraft as in claim 7 wherein the magnet is in shape a disk.

10. A personal watercraft as in claim 7 wherein the personal watercraft is one of the following:
surfboard;
stand-up paddle board;
kayak.

11. A personal watercraft as in claim 7 wherein the accessory is at least one of the following:
a waterproof pouch sized to contain a small electronic device such as a smart phone or a global positioning system (GPS) device;
a storage bag;
a bottle sleeve;
lighting device;
a tackle bag, configured to hold fishing tackle;
fishing rod holder;
fishing pole.

12. An attachment system for securing an accessory to a personal watercraft comprising:
a magnet;
a metal piece, wherein a first of the magnet and the metal piece is arranged to be attached or embedded within a top surface of the personal watercraft, wherein a second of the magnet and the metal piece is within or attached to the accessory, wherein the second of the magnet and the metal piece is arranged with the accessory so that a magnetic bond between the magnet and the metal piece holds the top accessory to the top surface, and wherein the second of the magnet and the metal piece is not the same as the first of the magnet and the metal piece;
a protective covering that protects the metal piece from water; and,
a protective covering that protects the magnet from water.

13. An attachment system as in claim 12 wherein the magnet is embedded in a bore within the top surface so that the top surface is smooth at a location where the magnet is embedded within the top surface.

14. An attachment system as in claim 12 wherein the metal piece is a metal disk.

15. An attachment system as in claim 12 wherein the magnet is attached by an adhesive to the top surface.

16. An attachment system as in claim 12 wherein the personal watercraft is one of the following:
surfboard;
stand-up paddle board;
kayak.

17. An attachment system as in claim 12 wherein the accessory is at least one of the following:
a waterproof pouch sized to contain a small electronic device such as a smart phone or a global positioning system (GPS) device;
a storage bag;
a bottle sleeve;
lighting device;
a tackle bag, configured to hold fishing tackle.

18. An attachment system as in claim 12 wherein the protective covering that protects the magnet from water is a waterproof coating over the magnet.

19. An attachment system as in claim 12 wherein the protective covering that protects the metal piece from water is a waterproof pouch within the accessory.

20. An attachment system as in claim 12 wherein the protective covering is a waterproof compartment within the accessory or top surface.
